(19) United States
(12) Patent Application Publication
(10) Pub. No.: US 2009/0146956 A1
(43) Pub. Date: Jun. 11, 2009

(54) PORTABLE ELECTRONIC DEVICE

(75) Inventors: JU-MEI LI, Tu-Cheng (TW); JUNG-CHIEH WONG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,733

(22) Filed: Dec. 27, 2007

(30) Foreign Application Priority Data
Dec. 7, 2007 (CN) 200710202935.8

(51) Int. Cl. G06F 3/02

(52) U.S. Cl. 345/168

(57) ABSTRACT

A portable electronic device (100) includes a main body (10), and a keypad module (12), a display module (14) and a system module (16) configured in the main body. The display module and the keypad module are respectively functioned based on the system module. The display module is electronically connected with the system module and includes a non-touch screen display (142). The keypad module includes at least one key, a keypad-sensing module (122), a judging module (124) and an executing module (126). The at least one key to be applied an action thereon by users. The keypad-sensing module configured for sensing the action of the at least one key. The judging module determines the instruction needed be executed according to the actions information sensed by the keypad-sensing module. The executing module performs an operation corresponding to the determined instruction of the judging module and sends the content of the operation performed by the executing module to the display module.

### BACKGROUND OF THE INVENTION

1. Field of the Invention

The present invention generally relates to portable electronic devices, such as mobile telephones, electronic notebooks, particularly to a portable electronic device having a keypad with a simple structure.

2. Discussion of the Related Art

With the development of wireless communication and information processing technologies, portable electronic devices, such as mobile telephones and personal digital assistants (PDAs), are now in widespread use. These portable electronic devices enable consumers to enjoy high technology services, almost anytime and anywhere. A keypad assembly as an input terminal has been an indispensable member of a portable electronic device.

Conventionally, a keypad assembly usually includes a plurality of keys, such as numeral keys, character keys and function keys. The plurality of keys of a keypad assembly of a portable electronic device is typically inserted through a plurality of holes of a housing of the portable electronic device. The keypad assembly has many elements and relatively complex structure.

The developing trend for portable electronic devices is to be compact in size while maintaining a relatively large display screen. In order to meet such requirements, size of the keypad of the portable electronic device is correspondingly reduced.

To reduce the size of keypads, a traditional portable electronic device is configured with a touch screen and a stylus used for inputting information on the touch screen. However, a cost of the touch screen is higher than a cost of a common LCD (liquid crystal display), and the touch screen can easily be damaged by the stylus or incaution of the user. Another traditional portable electronic device is configured with an external keypad instead of a common keypad, to save the space occupied by the common keypad in the portable electronic devices. But, the size of the external keypad is usually so large that is not convenient to be carried. In addition, the user must assemble the external keypad to the portable electronic device every time before inputting information by the external keypad, which makes it inconvenient for the user.

Therefore, a portable electronic device having a keypad with a low cost and a small space, is desired in order to overcome the above-described problems.

### SUMMARY

In one aspect thereof, a portable electronic device comprises a main body, a system module, a display module and a keypad module. The system module, the display module and the keypad module are respectively configured in the main body. The display module and the keypad module are respectively functioned based on the system module. The display module is electronically connected with the system module and includes a non-touch screen display. The keypad module is electronically connected with the system module and the display module. The keypad module comprises at least one key, a keypad-sensing module, a judging module and an executing module. The keypad-sensing module is triggered by the at least one key and senses an action of the at least one key. The judging module is electronically connected with the keypad-sensing module and determines the instruction needs be executed according to the actions information sensed by the keypad-sensing module. The executing module electronically connected with the judging module performs an operation corresponding to the determined instruction of the judging module and sends the content of the operation performed by the executing module to the display module.

Other advantages and novel features of the embodiments will become more apparent from the following detailed description thereof when taken in conjunction with the accompanying drawings.

### BRIEF DESCRIPTION OF THE DRAWINGS

Many aspects of the portable electronic device can be better understood with reference to the following drawings. Drawings are not necessarily drawn to scale, the emphasis instead being placed upon clearly illustrating the principles of the present portable electronic device. Moreover, in the drawings, like reference numerals designate corresponding parts throughout the several views, in which:

FIG. 1 is an isometric view of a portable electronic device, in accordance with a present embodiment; and

FIG. 2 is a function block of the portable electronic device shown in FIG. 1.

### DETAILED DESCRIPTION OF THE EMBODIMENTS

The present keypad is suitable for portable electronic devices, such as mobile phones, PDAs, and so on.

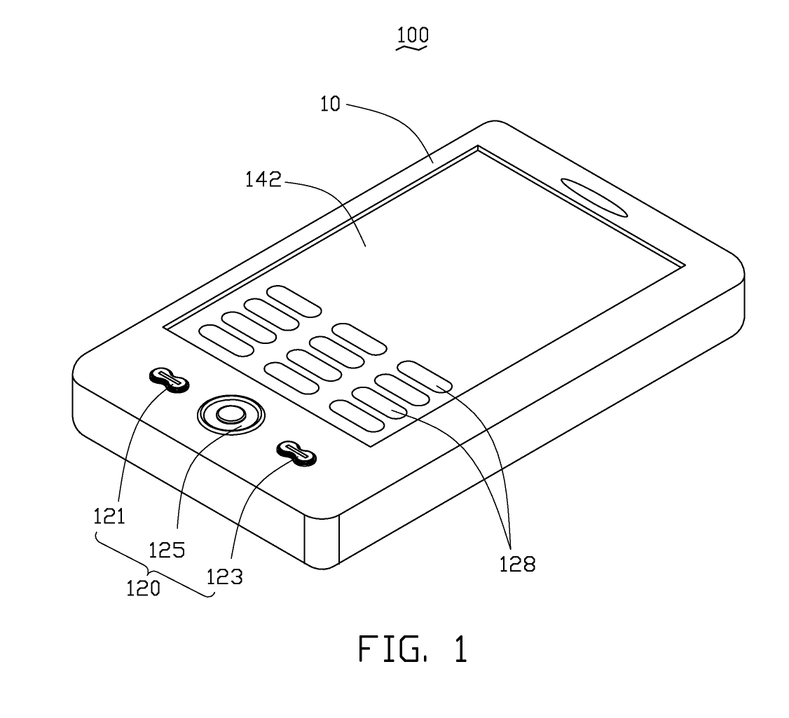

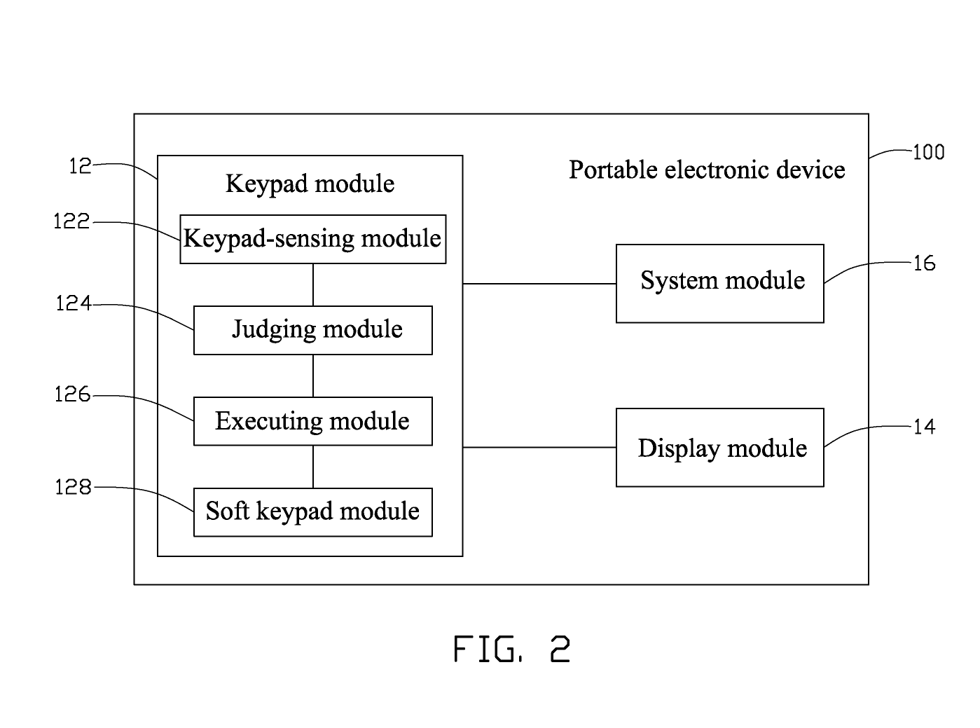

Referring to FIGS. 1 and 2, a portable electronic device 100 includes a main body 10, and a keypad module 12, a display module 14 and a system module 16 configured in the main body 10. The display module 14 is electronically connected with the keypad module 12 and includes a non-touch screen display 142. The system module 16 is respectively electronically connected with the keypad module 12 and the display module 14. The system module 16 acts as a platform of the portable electronic device 100. The keypad module 12 and the display module 14 are functioned on the platform of the system module 16.

In the present embodiment, the keypad module 12 includes a plurality of keys 120, a keypad-sensing module 122, a judging module 124, an executing module 126, and a soft keypad module 128. The plurality of keys are configured to be applied an action thereon by users and trigger the keypad-sensing module 122 after being pressed. The keypad-sensing module 122 is configured for sensing actions of the keys 120.

The plurality of keys 120 is configured for inputting information. The keys 120 include a first function key 121, a second function key 123 and a direction key 125. The first function key 121 and the second function key 123 are respectively used as a talk key and a hang-up key, or as a power-on key and a power-off key. The direction keys 125 includes an up key, a down key, a left key, a right key and an action key. It is noted that the direction keys 125 can only includes an up key and a down key, or a left key and a right key. The direction key 125 can also be a wheel key. When in use, the wheel key can be rotated up and down, or be rotated left or right.

The keypad-sensing module 122 senses the actions of the at least one key 120 including the first function key 121, the second function key 123 and the direction key 125, and sends the information of the actions to the judging module 124. The judging module 124 determines the instruction needed be executed according to the actions information sensed by the keypad-sensing module 122, and sends the determined instruction, that is, the instruction needs be executed to the executing module 126. The executing module 126 performs an operation corresponding to the determined instruction of the judging module 124. The non-touch screen display 142 of the display module 14 displays the content of the process performed by the executing module 126. The non-touch screen display 142 is a LCD.

Further referring to FIG. 1, when inputting words, characters, or numbers, the soft keypad module 128 is activated by operating the at least one key 120, and the executing module 126 performs the activation, then the soft keypad module 128 is displayed in the non-touch screen display 142 of the display module 14. The soft keypad module 128 herein includes a plurality of character/number keys, and the character/number keys are arranged in an array with three rows and four columns. Obviously, the arrangement of the character/number keys of the soft keypad module 128 can also be with the other form displayed in the non-touch screen display 142.

When use the direction key 125 to select a desired character or number, a character gather corresponding to the current character/number key is appeared in the non-touch screen display 142 above the plurality of the character/number keys of the soft keypad module 128, and the selected character is highlighted in display. The user can operate the direction key 125 to select a desired character or number, based on the coordination of the desired character or number in the soft keypad module 128. Then, the keypad-sensing module 122 senses the user's operation of the direction key 125, and sends the information about the operation to the judging module 124. The judging module 124 determines the desired character or number according to the information sent from the keypad-sensing module 122, and sends the determined instruction to the executing module 126. The executing module 126 selects the desired character or number according to the determined instruction of the judging module 124, and sends the desired character or number to the display module 22. If the user need not input any character or number into the portable electronic device 100, the soft keypad module 128 is not activated, and the judging module 124 and the executing module 126 only response to the action of the at least one key 120 sensed by the keypad-sensing module 122.

It should be understood that, one of the first function key 121 and the second function key 123 can be omitted. Different functions can be realized by different key-action combinations, for example, power on or power off the portable electronic device 100 by long pressing the first function key 121 or the second function 123, and switch interface of the portable electronic device 100 by continuously pressing the action key of the direction 125, and so on.

One advantage of the keypad and the portable electronic device 100 is that they has a considerable small size and enable the user to conveniently carry on the portable electronic device 100, by being configured with a combination of the direction key 125, function key and soft keypad module 128 instead of a traditional keypad. Additionally, the portable electronic device 100 integrates a cheap non-touch screen display 142 and the soft keypad module 128, reducing the cost and enabling the user to conveniently input information. Furthermore, the portable electronic device 100 has both a large screen and a small bulk.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device, comprising:
a main body;
a system module configured in the main body;
a display module configured in the main body and electronically connected with the system module, the display module including a non-touch screen display and being functioned based on the system module; and
a keypad module configured in the main body, electronically connected with the system module and the display module, the keypad module being functioned based on the system module and comprising:
at least one key to be applied an action thereon by users;
a keypad-sensing module configured for sensing the action of the at least one key;
a judging module electronically connected with the keypad-sensing module, the judging module determining an instruction needing to be executed according to the action sensed by the keypad-sensing module; and
an executing module electronically connected with the judging module, the executing module performing an operation corresponding to the determined instruction of the judging module and sending the content of the operation performed by the executing module to the display module.

2. The portable electronic device as claimed in claim 1, wherein the at least one key comprises at least one function key and a direction key.

3. The portable electronic device as claimed in claim 2, wherein the direction key comprises an up key and a down key, or includes a left key and a right key.

4. The portable electronic device as claimed in claim 3, wherein the direction key further comprises an action key.

5. The portable electronic device as claimed in claim 2, wherein the direction key includes a wheel key.

6. The portable electronic device as claimed in claim 1, further comprising a soft keypad module, when character or number needs to be input, the soft keypad module is activated by manually operating the at least one key, the executing module performing the activation, the soft keypad module being displayed on the non-touch screen display of the display module.

7. The portable electronic device as claimed in claim 6, wherein the soft keypad module comprises a plurality of character/number keys, the direction key being operated to select a desired character or number based on the coordination of the desired character or number in the soft keypad module.
